(19) United States
(12) Patent Application Publication
(10) Pub. No.: US 2017/0331600 A1
(43) Pub. Date: Nov. 16, 2017

(54) METHOD FOR ENHANCING THE ROBUSTNESS OF UPLINK COORDINATED MULTI-POINT PROCEDURE IN LTE NETWORK

(71) Applicant: TELEKOM MALAYSIA BERHAD, Kuala Lumpur (MY)

(72) Inventors: Ahmad Kamsani bin Samingan, Bandar Baru Bangi (MY); Chun Yeow Yeoh, Petaling Jaya (MY); Mohammad Harris bin Mokhtar, Bandar Baru Bangi (MY); Amir Razif bin Abdul Rahim, Bandar Baru Bangi (MY)

(73) Assignee: TELEKOM MALAYSIA BERHAD, Kuala Lumpur (MY)

(21) Appl. No.: 15/593,517

(22) Filed: May 12, 2017

(30) Foreign Application Priority Data
May 13, 2016 (MY) PI2016000890

(51) Int. Cl. H04L 5/00; H04W 24/10

(52) U.S. Cl. CPC H04L 5/0035; H04W 24/10

(57) ABSTRACT

A method for enhancing robustness of uplink coordinated multi-point (UL CoMP) procedure in a long term evolution (LTE) communication network (100) is provided herein. The method includes selecting at least one coordinated cell (112), by a serving cell (111), for uplink (UL) monitoring of user equipment (113). The method further includes sending at least one UL activate monitoring command message, by the serving cell (111), to the at least one coordinated cell (112). The method further includes receiving an event A3 measurement report by the serving cell (111), from the at least one coordinated cell (112). The method further includes performing UL CoMP procedure, by the serving cell (111), upon receiving the event A3 measurement report.

### CROSS-REFERENCE TO RELATED APPLICATION

This application claims priority to Malaysian Patent Application No. PI2016000890 filed on May 16, 2013, and which application is incorporated herein by reference in its entirety.

### FIELD OF THE INVENTION

Embodiments of the present invention, generally relate to long-term evolution (LTE) network, and in particular relate to a method for enhancing robustness of uplink coordinated multi-point procedure in the LTE network.

### BACKGROUND

Communication networks have evolved exponentially over last two decade. In addition to communication, communication networks are delivering data over large distances and driving the information economy. It has been constant endeavor of communication industry to further improve the communication networks and communication technology to deliver data at higher speed, more secure, more efficient, and more robust.

After success of 2G and 3G, focus is now at 4G (i.e., LTE) networks. To cover maximum area, the LTE wireless communication network generally includes a number of evolved nodes of base stations called as eNodeB (or eNB) that support communication for a number of user equipment (UE). A UE communicate with an eNB via a downlink and an uplink. The downlink (DL) refers to communication link from the eNB to the UE, and the uplink (UL) refers to the communication link from the UE to the eNB. As illustrated in FIG. 1A, whenever a UE 103 located at a cell edge sends the data on the UL to a serving cell 101, it may cause interference to data transmissions sent by other UEs 104 to neighboring cells 102. Correspondingly, the data transmission from the UE 105 may also observe interference from the data transmissions 106 sent by the other UEs. This interference may degrade the performance of all affected UEs.

Conventionally, interference issue has been tried to be solved using various methods, however, they suffer from one or other issues. For example, one of such conventional method tries to utilize handover in the wireless network with coordinated multi-point (CoMP) transmission/reception scheme. The CoMP slave (first base station) is able to decode measurement reports sent by a UE destined to the CoMP master (second base station). Also, the CoMP slave or the first base station can send the handover command to the UE via the instruction from the CoMP master or the second base station.

Another conventional method provides a handover method based on an uplink signal, wherein a source base station sends a trigger message to a user equipment to send an uplink signal used for handover. The source base station receives a notification message by one or more other base stations according to detection of the uplink signal and determines a target base station from the one or more other base stations according to the notification message, and performs handover of the user equipment.

Another conventional method, tries to solve power imbalance between a macro cell and a small cell in heterogonous network. The method identifies the uplink boarder between the macro cell and the small cell, triggers a message to UE to send the measurement report about the neighboring cell, the serving cell then decides to whether the neighboring cell should start monitoring the uplink connection quality of the UE and offloads the uplink traffic to the neighbor cell.

Yet another conventional method provides a method of selecting access points for CoMP uplink reception based on evaluating the measurement reports originating from uplink measurements.

All of the conventional methods discuss methods relate to only handover, measurement reporting by the UE, feedback schemes and coordinated cell selection, or even UL monitoring based on SRS. It is possible that sometimes triggering of CoMP procedure may get delayed or even fail to trigger, in these conventional methods. Further, all of the conventional methods described above have not solved issue of interference up to a satisfactory level.

Therefore, there is a need for an improved communication method and system for solving the issue of interference, and enhancing the robustness of CoMP procedure in LTE wireless communication networks.

### SUMMARY

According to an aspect of the present disclosure, a method for enhancing robustness of uplink coordinated multi-point (UL CoMP) procedure in a long term evolution (LTE) communication network is provided herein. The method includes selecting at least one coordinated cell (112), by a serving cell (111), for uplink (UL) monitoring of a user equipment (113). The method further includes sending at least one UL activate monitoring command message, by the serving cell (111), to the at least one coordinated cell (112). The method further includes receiving an event A3 measurement report by the serving cell (111), from the at least one coordinated cell (111). The method further includes performing UL CoMP procedure, by the serving cell (111), upon receiving the event A3 measurement report.

According to another aspect of the present disclosure, a method for a coordinated cell to perform uplink (UL) monitoring of event A3 measurement report from a user equipment (UE) in a long term evolution (LTE) communication network is provided. The method includes receiving, by the coordinated cell (112), a UL activate monitoring command message from a serving cell (111). Further, the method includes allocating resources for the UL monitoring of the user equipment (113) and forwarding an event A3 measurement report to the serving cell (111). The method further includes deactivating the UL monitoring after receiving of scheduling information from the serving cell (111).

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a schematic diagram of the LTE communication network, in which UE is located at the overlapping of serving cells and neighboring cell, according to an embodiment of the present invention;

FIG. 1B illustrates schematic diagram of the LTE communication network, in which the UE is located at the overlapping of the serving cell and the coordinated cell, and the UE located at cell center of coordinated cell is no longer interfered by the UE located at cell edge in the case of UL transmission, according to an embodiment of the present invention;

FIG. 2 illustrates LTE flow diagram for enabling UL CoMP, according to an embodiment of the present invention;

FIG. 3 illustrates the LTE flow diagram for enabling UL CoMP with UL monitoring supported by the coordinated cell, according to an embodiment of the present invention;

FIG. 4 illustrates the LTE flow diagram for ANR, according to an embodiment of the present invention;

FIG. 5 illustrates E-UTRAN Cell Global Identifier (ECGI) used by Automatic Neighbor Relation (ANR) function in LTE Self Organizing Network (SON), according to an embodiment of the present invention;

FIG. 6 illustrates a flow chart of enhancing the robustness of UL CoMP by introducing the UL monitoring of event A3 measurement report at the coordinated cell, according to an embodiment of the present invention;

FIG. 7A illustrates flowchart of the serving cell enabling the UL monitoring of a plurality of selected coordinated cells, according to an embodiment of the present invention;

FIG. 7B illustrates the UL activate monitoring command message format utilizing the S1AP and X2AP protocol, according to an embodiment of the present invention;

FIG. 8A illustrates flow chart of the coordinated cell performing its UL monitoring and forwarding the event A3 measurement report to the serving cell, according to an embodiment of the present invention;

FIG. 8B illustrates forwarded event A3 measurement report message format utilizing the S1AP and X2AP protocol, according to an embodiment of the present invention;

FIG. 9A illustrates is a flowchart of the serving cell disabling the UL monitoring of a plurality of selected coordinated cells, according to an embodiment of the present invention;

FIG. 9B illustrates the UL deactivate monitoring command message format utilizing the S1AP and X2AP protocol, according to an embodiment of the present invention;

FIG. 10 illustrates a flowchart of the coordinated cell disabling its UL monitoring, according to an embodiment of the present invention; and

FIG. 11 illustrates a flowchart of incorporating the invention with the automatic neighbor registration (ANR), according to an embodiment of the present invention.

To facilitate understanding, like reference numerals have been used, where possible, to designate like elements common to the figures.

### DETAILED DESCRIPTION

As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

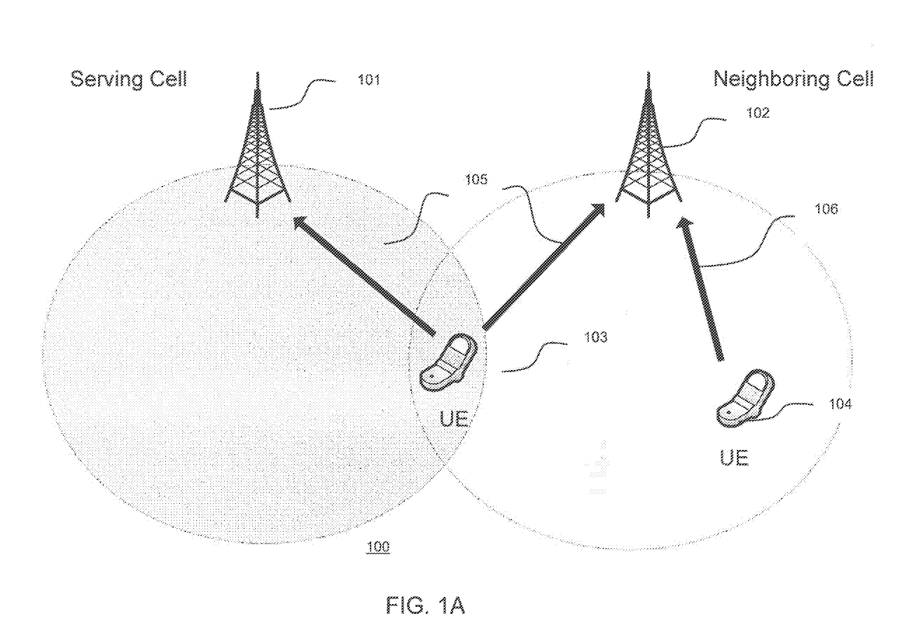

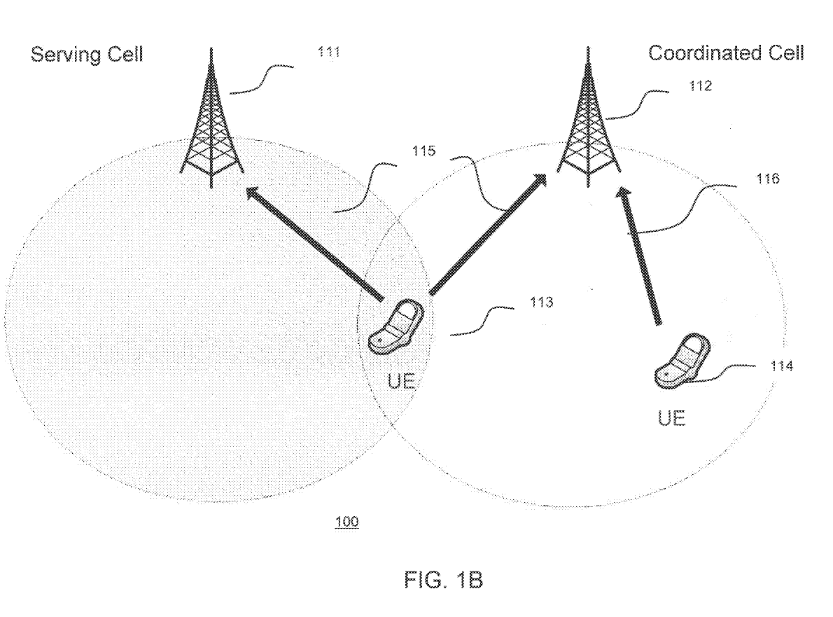

FIG. 1A illustrates a schematic representation of a long term evolution (LTE) wireless communication network (100), according to an embodiment of the present invention. As shown in FIG. 1A, the LTE wireless communication network 100 includes a serving cell (101) and a neighbouring cell (102). The serving cell (101) includes user equipment (103) that transmits data to the serving cell (101). The neighbouring cell (102) includes user equipment (104) that transmits data to the neighbouring cell (102). However, whenever the UE (103) is located at a cell edge and sends the data on the uplink (UL) to the serving cell (101), it may cause interference to data transmissions sent by other UEs (104) to neighboring cells (102). Correspondingly, the data transmission from the UE (105) may also observe interference from the data transmissions (106) sent by the other UEs. This interference may degrade the performance of all affected UEs.

According to an embodiment of the present invention, the serving cell is configured to enable coordinated multi-point (CoMP) procedure to avoid the interference. Those skilled in the art will appreciate that coordinated multi-point (CoMP), being standardized in 3GPP LTE-Advanced networks, allows multi-cell cooperative processing to mitigate inter-cell interference (ICI) and the communication network operates at higher effective signal-to-interference-plus-noise ratios (SINRs). In the uplink, multiple cells may cooperate to improve the reception performance by increasing the number of antenna spatial macro-diversity and subsequently the uplink throughput at the cell edge of the UE is improved. As illustrated in FIG. 1B, the neighboring cell (102) now becomes the coordinated cell (112), both the interference 115 to the UE (114) and the interference (116) to the UE (113) is mitigated. However, according to an embodiment of the present invention, the triggering of UL CoMP may fail or delay if the event A3 measurement report is lost and not received by the serving cell (as explained below).

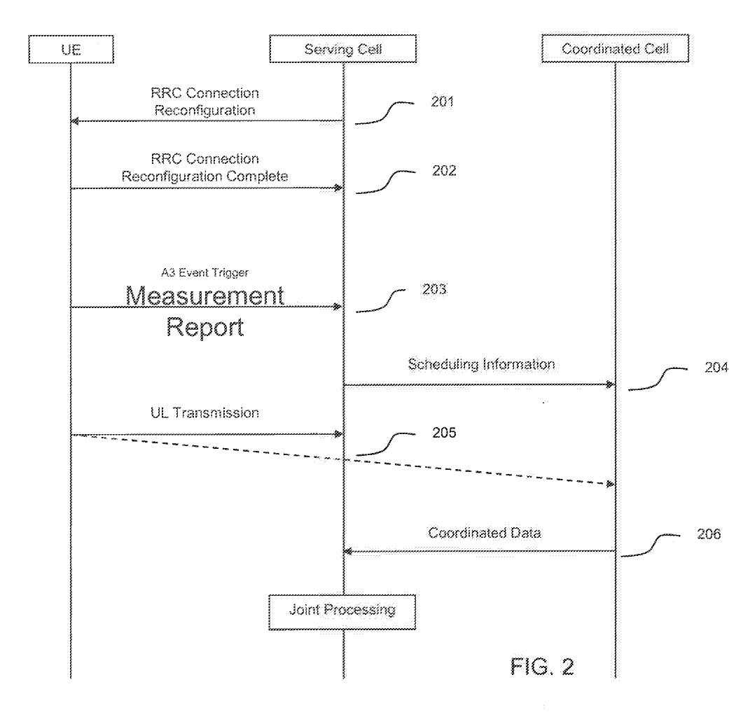

In an embodiment, as shown in FIG. 2, the serving cell (111) is configured to first send radio resource control (RRC) connection reconfiguration message to the user equipment (111). The user equipment (111) sends a message to the serving cell, once the RRC connection reconfiguration is completed. The user equipment (113) is further configured to send A3 event measurement report to the serving cell (111). In an embodiment, the LTE Event A3 is triggered when a neighboring cell becomes better than the serving cell (111) by an offset. In an embodiment, event A3 measurement report sent by UE contains a physical cell identity associated with their respective reference signal received power result information event (rsrpResult IEs) located at the measure results information event (MeasResults IE).

### Event A3 Measurement Report:

| | |
|---|---|
| -- ASN1START | |
| MeasurementReport ::= | SEQUENCE { |

| | |
|---|---|
| criticalExtensions | CHOICE { |

| | |
|---|---|
| c1 | CHOICE{ |
| measurementReport-r8 | MeasurementReport-r8-IEs, |

```
                  spare7 NULL,
                  spare6 NULL, spare5 NULL, spare4 NULL,
                  spare3 NULL, spare2 NULL, spare1 NULL
            },
```

| | |
|---|---|
| criticalExtensionsFuture | SEQUENCE { } |
| } | |
| } | |

| | |
|---|---|
| MeasurementReport-r8-IEs ::= | SEQUENCE { |

| | | |
|---|---|---|
| measResults | MeasResults, | |
| nonCriticalExtension | MeasurementReport-v8a0-IEs | OPTIONAL |
| } | | |

MeasurementReport-v8a0-IEs ::= SEQUENCE {

| | | |
|---|---|---|
| lateNonCriticalExtension | OCTET STRING | OPTIONAL, |
| nonCriticalExtension | SEQUENCE { } | OPTIONAL |
| } | | |
| -- ASN1STOP | | |

### Measure Results Information Event:

| | |
|---|---|
| -- ASN1START | |
| MeasResults ::= | SEQUENCE { |

| | |
|---|---|
| measId | MeasId, |

| | |
|---|---|
| measResultPCell | SEQUENCE { |

| | |
|---|---|
| rsrpResult | RSRP-Range, |
| rsrqResult | RSRQ-Range |

| | |
|---|---|
| }, | |
| measResultNeighCells | CHOICE { |

| | |
|---|---|
| measResultListEUTRA | MeasResultListEUTRA, |
| measResultListUTRA | MeasResultListUTRA, |
| measResultListGERAN | MeasResultListGERAN, |
| measResultsCDMA2000 | MeasResultsCDMA2000, |
| ... | |

}

| | | | OPTIONAL, |
|---|---|---|---|
| ..., | | | |
| [[ | measResultForECID-r9 | MeasResultForECID-r9 | OPTIONAL |
| ]], | | | |
| [[ | locationInfo-r10 | LocationInfo-r10 | OPTIONAL, |

| | |
|---|---|
| measResultServFregList-r10 | MeasResultServFregList-r10 |

```
      OPTIONAL
      ]],
```

| | | | |
|---|---|---|---|
| [[ | measId-v1250 | MeasId-v1250 | OPTIONAL, |
| | measResultPCell-v1250 | RSRQ-Range-v1250 | OPTIONAL, |

| | |
|---|---|
| measResultCSI-RS-List-r12 | MeasResultCSI-RS-List-r12 |

```
      OPTIONAL
      ]]
}
MeasResultListEUTRA ::= SEQUENCE(SIZE(1..maxCellReport) )OF MeasResultEUTRA
MeasResultEUTRA ::= SEQUENCE {
```

| | |
|---|---|
| physCellId | PhysCellId, |
| cgi-Info | SEQUENCE { |

| | | |
|---|---|---|
| cellGlobalId | CellGlobalIdEUTRA, | |
| trackingAreaCode | TrackingAreaCode, | |
| plmn-IdentityList | PLMN-IdentityList2 | OPTIONAL |

| | |
|---|---|
| } | OPTIONAL, |

| | |
|---|---|
| measResult | SEQUENCE { |

| | | |
|---|---|---|
| rsrpResult | RSRP-Range | OPTIONAL, |
| rsrqResult | RSRQ-Range | OPTIONAL, |
| ..., | | |

| | | |
|---|---|---|
| [[ additionalSI-Info-r9 | AdditionalSI-Info-r9 | OPTIONAL |
| ]], | | |
| [[ primaryPLMN-Suitable-r12 | ENUMERATED {true} | OPTIONAL, |
| measResult-v1250 | RSRQ-Range-v1250 | OPTIONAL |
| ]] | | |

}
}
-- ASN1STOP

In an embodiment, following mapping table may be used for the reference signal received power (RSRP) value used in the rsrpResult IE for the event A3 measurement report.

TABLE
(3GPP TS 36.133): RSRP measurement report mapping

| Reported value | Measured quantity value | Unit |
|---|---|---|
| RSRP_00 | RSRP <−140 | dBm |
| RSRP_01 | −140 ≦ RSRP < −139 | dBm |
| RSRP_02 | −139 ≦ RSRP < −138 | dBm |
| . . . | . . . | . . . |
| RSRP_95 | −46 ≦ RSRP < −45 | dBm |
| RSRP_96 | −45 ≦ RSRP < −44 | dBm |
| RSRP_97 | −44 ≦ RSRP | dBm |

According to an embodiment of the present invention, the PhysCellId IE is a unique physical (PHY) cell identity ranging from 0 to 503 used for isolating the cells in a same coverage area. Those skilled in the art will appreciate that event A3 is cited in 3GPP TS 36.331 standard and is defined as a neighboring cell whose offset is better than the serving cell (101). In an embodiment, the A3 offset, the reporting interval and etc. are determined by the RRC Connection Reconfiguration message 301 sent by the eNB to the UE. RRC Connection Reconfiguration message includes ReportConfigEUTRA information element (IE) with event A3 information event (eventA3 IE).

### VARmeas Config UE Variable:

| | |
|---|---|
| -- ASN1START | |
| VarMeasConfig ::= | SEQUENCE { |

-- Measurement identities

| | | |
|---|---|---|
| measIdList | MeasIdToAddModList | OPTIONAL, |
| measIdListExt-r12 | MeasIdToAddModListExt-r12 | OPTIONAL, |

-- Measurement objects

| | | |
|---|---|---|
| measObjectList | MeasObjectToAddModList | OPTIONAL, |
| measObjectList-v9i0 | MeasObjectToAddModList-v9e0 | OPTIONAL, |

-- Reporting configurations

| | | |
|---|---|---|
| reportConfigList | ReportConfigToAddModList | |
| OPTIONAL, | | |
| -- Other parameters | | |
| quantityConfig | QuantityConfig | OPTIONAL, |
| measScaleFactor-r12 | MeasScaleFactor-r12 | OPTIONAL, |
| s-Measure | INTEGER (−140..−44) | OPTIONAL, |
| speedStatePars | CHOICE { | |
| release | NULL, | |
| setup | SEQUENCE { | |

| | |
|---|---|
| mobilityStateParameters | MobilityStateParameters, |
| timeToTrigger-SF | SpeedStateScaleFactors |
| } | |
| } OPTIONAL, | |

| | | |
|---|---|---|
| allowInterruptions-r11 | BOOLEAN | OPTIONAL |
| } | | |
| -- ASN1STOP | | |

### ReportConfigToAddModList Information Element:

-- ASN1START
ReportConfigToAddModList ::= SEQUENCE (SIZE
(1..maxReportConfigId)) OF ReportConfigToAddMod

| | |
|---|---|
| ReportConfigToAddMod ::= | SEQUENCE { |

| | |
|---|---|
| reportConfigId | ReportConfigId, |
| reportConfig | CHOICE { |

| | |
|---|---|
| reportConfigEUTRA | ReportConfigEUTRA, |
| reportConfigInterRAT | ReportConfigInterRAT |
| } | |
| } | |
| -- ASN1STOP | |

### ReportConfigEUTRA Information Element:

| | |
|---|---|
| -- ASN1START | |
| ReportConfigEUTRA ::= | SEQUENCE { |

| | |
|---|---|
| triggerType | CHOICE { |

| | |
|---|---|
| event | SEQUENCE { |

| | |
|---|---|
| eventId | CHOICE { |

| | |
|---|---|
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 | SEQUENCE { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresholdEUTRA, |
| a5-Threshold2 | ThresholdEUTRA |
| }, | |
| ..., | |
| eventA6-r10 | SEQUENCE { |
| a6-Offset-r10 | INTEGER (−30..30), |
| a6-ReportOnLeave-r10 | BOOLEAN |
| }, | |
| eventC1-r12 | SEQUENCE { |
| c1-Threshold-r12 | ThresholdEUTRA-v1250, |
| c1-ReportOnLeave-r12 | BOOLEAN |
| }, | |
| eventC2-r12 | SEQUENCE { |
| c2-RefCSI-RS-r12 | MeasCSI-RS-Id-r12, |
| c2-Offset-r12 | INTEGER (−30..30), |
| c2-ReportOnLeave-r12 | BOOLEAN |
| } | |
| }, | |

| | |
|---|---|
| hysteresis | Hysteresis, |
| timeToTrigger | TimeToTrigger |
| }, | |
| periodical | SEQUENCE { |
| purpose | ENUMERATED { |
| | reportStrongestCells, reportCGI} |
| } | |

| | |
|---|---|
| }, | |
| triggerQuantity | ENUMERATED {rsrp, rsrq}, |
| reportQuantity | ENUMERATED {sameAsTriggerQuantity, both}, |
| maxReportCells | INTEGER (1..maxCellReport), |
| reportInterval | ReportInterval, |
| reportAmount | ENUMERATED {r1, r2, r4, r8, r16, r32, r64, infinity}, |
| ..., | |

| | |
|---|---|
| [[si-RequestForHO-r9 ENUMERATED {setup} OPTIONAL, | -- Cond |
| reportCGI | |
| ue-RxTxTimeDiffPeriodical-r9 ENUMERATED {setup} OPTIONAL | -- Need OR |
| -- ASN1STOP | |

Further, the serving cell (111) is configured to receive the event A3 measurement reporting (203). The serving cell (111) is further configured to send the scheduling information (204) to the coordinated cell (112). In an embodiment, UL transmission (205) from the UE can be received by both the serving cell (111) and the coordinated cell (112). Subsequently, the coordinated cell (112) sends the coordinated data (206) to the serving cell (111) for joint processing. During the joint processing, the serving cell (111) applies the interference mitigation technique or signal combining technique in PHY layer to optimize the network performance. However, according to an embodiment of the present invention, the triggering of UL CoMP may fail or delay if the event A3 measurement report is lost and not received by the serving cell. Further, for heterogeneous network comprising different coverage cells, such as macro-cells, micro-cells, pico-cells and femto-cells, the probability of the serving cell, usually macro-cell, not receiving the event A3 measurement report is higher due to the power imbalance.

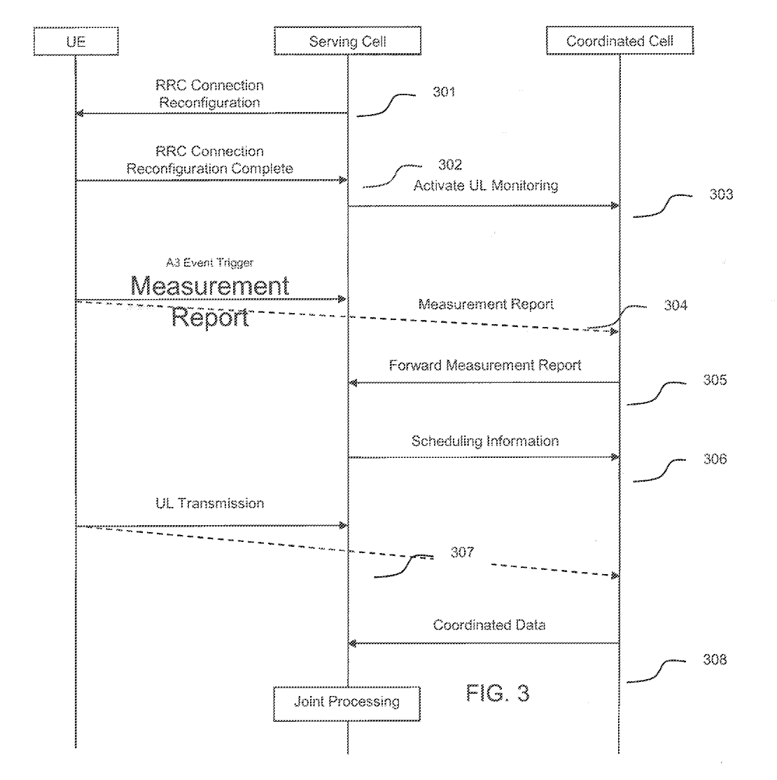

To solve the problem of not receiving of the A3 measurement report, according to an embodiment of the present invention, the serving cell (111) is configured to activate UL monitoring by a coordinated cell (112) and receives the A3 measurement report from the coordinated cell (as illustrated in FIG. 3). In an embodiment, during operation, the serving cell (111) first sends the RRC Connection Reconfiguration message (301) to the UE (113). The UE (113) replies with RRC Connection Reconfiguration Complete message (302) to the serving cell (111). The serving cell (111) then sends the UL activate monitoring command message (303) to the coordinated cell (112). Whenever the event A3 is triggered, the UE (113) sends the measurement report (304) to the serving cell (111). The coordinated cell (112) also receives the same measurement report (304) and forwards the measurement reports (305) to the serving cell (111). The serving cell (111) then activates the UL CoMP by sending scheduling information (306) to the coordinated cell (112). The UL transmission (307) is received by both the serving cell (111) and the coordinated cell (112). The coordinated cell (112) sends the coordinated data (308) to the serving cell (111) for joint processing.

Those skilled in the art will appreciate that even if the measurement report (304) is not received by the serving cell (111), the serving cell (111) can still trigger the UL CoMP based on the forwarded measurement report (305) from the coordinated cell (112). In an embodiment, the message exchange between the service cell (111) and the coordinated cell (112) may either utilize X2 interface or S1 interface.

Thus, according to an embodiment of the present invention, a method for enhancing the robustness of UL CoMP is provided. The UE located at cell edge can experience the benefits of UL CoMP as soon as possible by enabling UL measurement for coordinated cell and thus it avoids the serving cell not hearing the measurement report from the UE over the air. In another embodiment, the method further may select also the newly added cells for UL monitoring when the automatic neighbor relation (ANR) procedures have been performed.

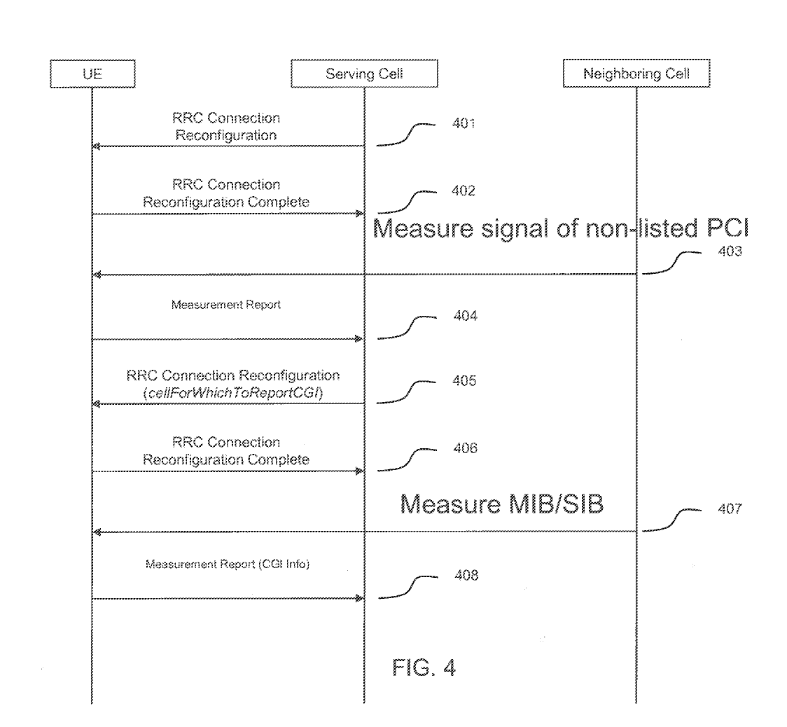

As illustrated in FIG. 4, whenever the eNB triggers the measurement command, RRC Connection Reconfiguration message (401), to a UE, the UE performs the cell measurement or cell detection surrounding it. If the information event of cellForVVhichToReportCGI IE (as illustrated below) appeared in the RRC Connection Reconfiguration message (605) sent by the eNB, the measurement report (408) from the UE should include the cells that matched evolved-Universal Mobile Telecommunications System Terrestrial Radio Access Network (E-URTAN) cell global ID (i.e., ECGI). The eNB can then lookup a transport layer address to the new eNB, update its neighbor relation list and setup the X2 interface.

### VarMeasConfig User Equipment (UE) Variable:

-- ASN1START
VarMeasConfig ::= SEQUENCE {
-- Measurement identities

| | | |
|---|---|---|
| measIdList | MeasIdToAddModList | OPTIONAL, |
| measIdListExt-r12 | MeasIdToAddModListExt-r12 | OPTIONAL, |

-- Measurement objects

| | | |
|---|---|---|
| measObjectList | MeasObjectToAddModList | OPTIONAL, |
| measObjectList-v9i0 | MeasObjectToAddModList-v9e0 | OPTIONAL, |

-- Reporting configurations

| | | |
|---|---|---|
| reportConfigList | ReportConfigToAddModList | OPTIONAL, |
| -- Other parameters | | |
| quantityConfig | QuantityConfig | OPTIONAL, |
| measScaleFactor- | MeasScaleFactor-r12 | OPTIONAL, |
| r12 | | |
| s-Measure | INTEGER (−140..−44) | OPTIONAL, |
| speedStatePars | CHOICE { | |
| release | NULL, | |
| setup | SEQUENCE { | |

| | |
|---|---|
| mobilityStateParameters | MobilityStateParameters, |
| timeToTrigger-SF | SpeedStateScaleFactors |
| } | |

| | |
|---|---|
| } | OPTIONAL, |
| allowInterruptions-r11 BOOLEAN | OPTIONAL |
| } | |
| -- ASN1STOP | |

### MeasObjectToAddModList Information Element:

| | | |
|---|---|---|
| -- ASN1START | | |
| MeasObjectToAddModList ::= | SEQUENCE(SIZE(1..maxObjectId)) | OF |
| MeasObjectToAddMod | | |
| MeasObjectToAddModList-v9e0 ::= | SEQUENCE(SIZE(1..maxObjectId)) | OF |
| MeasObjectToAddMod-v9e0 | | |
| MeasObjectToAddMod ::= SEQUENCE { | | |
| measObjectId | MeasObjectId, | |
| measObject | CHOICE { | |
| measObjectEUTRA | MeasObjectEUTRA, | |
| measObjectUTRA | MeasObjectUTRA, | |
| measObjectGERAN | MeasObjectGERAN, | |
| measObjectCDMA2000 | MeasObjectCDMA2000, | |
| ... | | |
| } | | |
| } | | |

MeasObjectToAddMod-v9e0 ::= SEQUENCE {

| | |
|---|---|
| measObjectEUTRA-v9e0 | MeasObjectEUTRA-v9e0 OPTIONAL -- |
| Cond eutra | |
| } | |
| -- ASN1STOP | |

### MeasObjectEUTRA Information Element:

-- ASN1START
MeasObjectEUTRA ::= SEQUENCE {

| carrierFreq | ARFCN-ValueEUTRA, | | |
|---|---|---|---|
| allowedMeas Bandwidth | AllowedMeas Bandwidth, | | |
| presenceAntennaPort1 | PresenceAntennaPort1, | | |
| neighCellConfig | NeighCellConfig, | | |
| offsetFreq | Q-OffsetRange | DEFAULT dB0, | |
| -- Cell list | | | |
| cellsToRemoveList | CellIndexList | OPTIONAL, | -- Need ON |
| cellsToAddModList | CellsToAddModList | OPTIONAL, | -- Need ON |
| -- Black list | | | |
| blackCellsToRemoveList | CellIndexList | OPTIONAL, | -- Need ON |
| blackCellsToAddModList | BlackCellsToAddModList OPTIONAL, | | -- Need ON |
| cellForWhichToReportCGI | PhysCellId | OPTIONAL, | -- Need ON |
| ..., | | | |
| [[measCycleSCell-r10 | MeasCycleSCell-r10 | OPTIONAL, | -- Need ON |

measSubframePatternConfigNeigh-r10 MeasSubframePatternConfigNeigh-

| r10 OPTIONAL | | -- Need ON |
|---|---|---|
| ]], | | |
| [[widebandRSRQ-Meas-r11 BOOLEAN | OPTIONAL -- Cond WB-RSRQ | |
| ]], | | |
| [[ altTTT-CellsToRemoveList-r12 | CellIndexList OPTIONAL, | -- Need ON |

| altTTT-CellsToAddModList-r12 | | AltTTT-CellsToAddModList-r12 |
|---|---|---|
| OPTIONAL, | -- Need ON | |
| t312-r12 | | CHOICE { |
| | release | NULL, |
| | setup | NUMERATED {ms0, ms50, ms100, |
| | | ms200, ms300, ms400, ms500, |
| | | ms1000} |

| | | |
|---|---|---|
| } | OPTIONAL, | -- Need ON |
| reducedMeasPerformance-r12 | BOOLEAN OPTIONAL, | -- Need ON |

| | |
|---|---|
| measDS-Config-r12 | MeasDS-Config-r12 OPTIONAL |
| -- Need ON | |
| ]] | |
| } | |

| | |
|---|---|
| MeasObjectEUTRA-v9e0 ::= | SEQUENCE { |
| carrierFreq-v9e0 | ARFCN-ValueEUTRA-v9e0 |
| } | |
| CellsToAddModList ::= | SEQUENCE (SIZE(1..maxCellMeas)) OF CellsToAddMod |
| CellsToAddMod ::= SEQUENCE { | |
| cellIndex | INTEGER (1..maxCellMeas), |
| physCellId | PhysCellId, |
| cellIndividualOffset | Q-OffsetRange |
| } | |
| BlackCellsToAddModList ::= | SEQUENCE(SIZE(1..maxCellMeas)) OF |
| BlackCellsToAddMod | |

BlackCellsToAddMod ::= SEQUENCE {

| | |
|---|---|
| cellIndex | INTEGER (1..maxCellMeas), |
| physCellIdRange | PhysCellIdRange |
| } | |

MeasCycleSCell-r10 ::= ENUMERATED {sf160, sf256, sf320, sf512,

sf640, sf1024, sf1280, spare1}

| | |
|---|---|
| MeasSubframePatternConfigNeigh-r10 ::= | CHOICE { |

| | |
|---|---|
| release | NULL, |
| setup | SEQUENCE { |

| | |
|---|---|
| measSubframePatternNeigh-r10 | MeasSubframePattern-r10, |
| measSubframeCellList-r10 | MeasSubframeCellList-r10 OPTIONAL |
| -- Cond always | |
| } | |
| } | |

| | |
|---|---|
| MeasSubframeCellList-r10 ::= | SEQUENCE(SIZE(1..maxCellMeas))OF PhysCellIdRange |

AltTTT-CellsToAddModList-r12 ::= SEQUENCE(SIZE(1..maxCellMeas)) OF AltTTT-
CellsToAddMod-r12

| | |
|---|---|
| AltTTT-CellsToAddMod-r12 ::= | SEQUENCE { |
| cellIndex-r12 | INTEGER (1..maxCellMeas), |
| physCellIdRange-r12 | PhysCellIdRange |
| } | |
| -- ASN1STOP | |

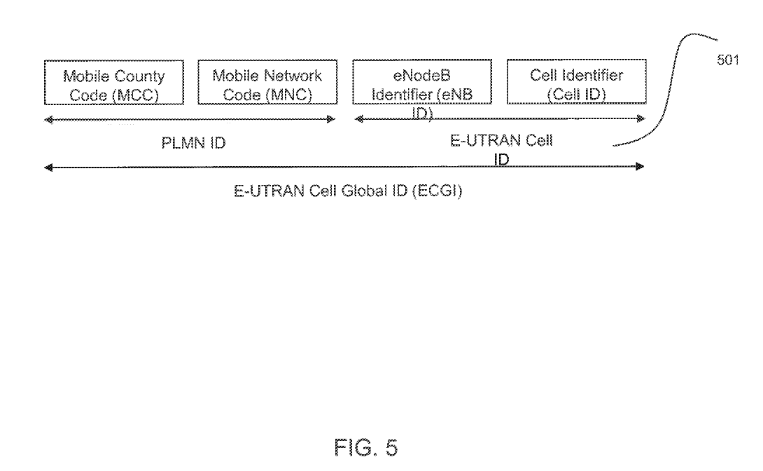

FIG. 5 illustrates E-UTRAN Cell Global Identifier (ECGI), which is used for automatic neighbor relation (ANR) function, according to an embodiment of the present invention. Those skilled in the art will appreciate that the ANR function defined in 3GPP TR 36.902 and 3GPP TS 36.300 is introduced by Self Organizing Network (SON).

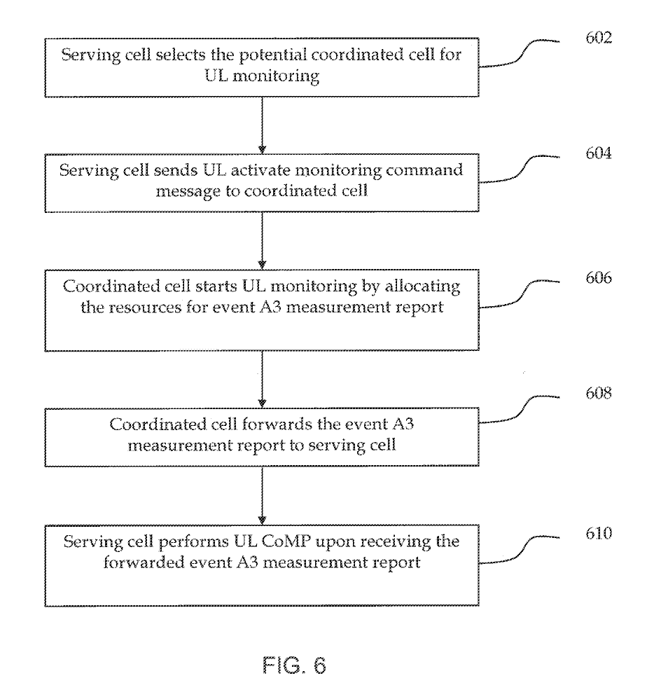

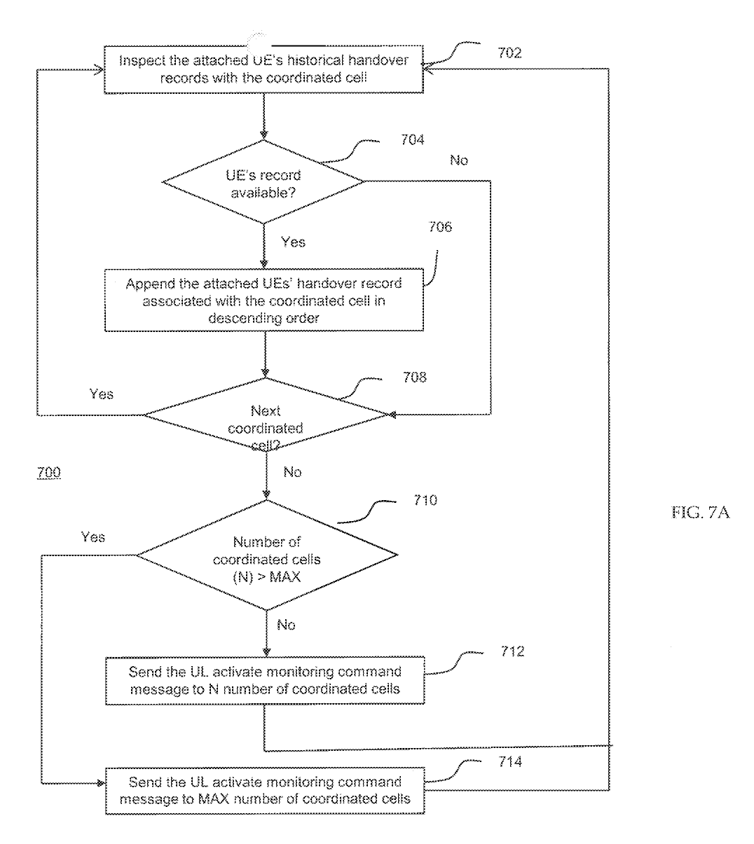

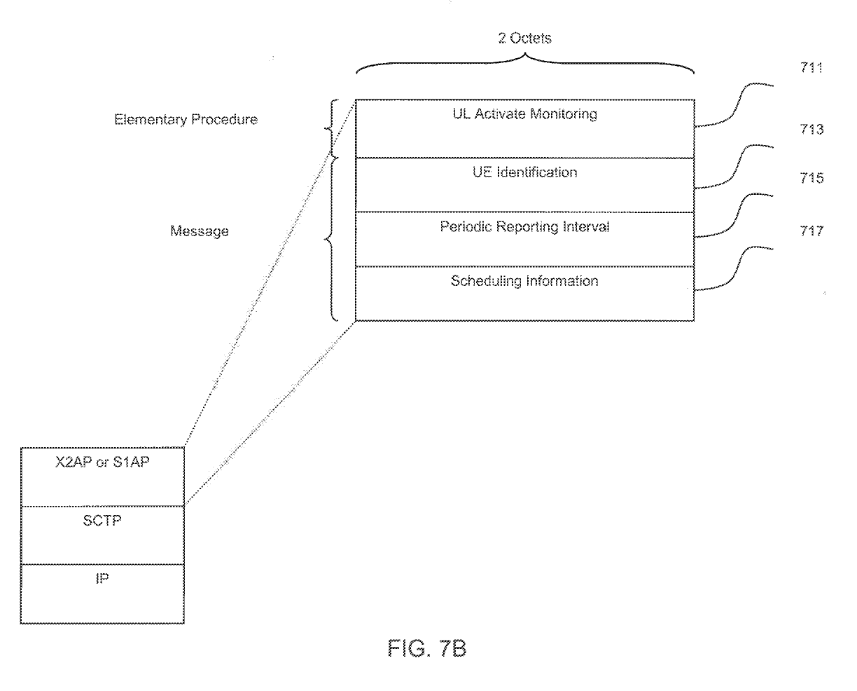

FIG. 6 illustrates a method (600) to enhance robustness of uplink coordinated multi-point in LTE network, according to an embodiment of the present invention. Initially, at step 602, the serving cell (111) selects potential coordinated cell for uplink (UL) monitoring. At step 604, the serving cell (111) sends UL activate monitoring command message to the coordinated cell (112). At step 606, the coordinated cell (112) starts UL monitoring by allocating resources for event A3 measurement report. At step 608, the coordinated cell (112) forwards the event A3 measurement report to the serving cell (101). At step 610, the serving cell (111) performs UL CoMP upon receiving the forwarded event A3 measurement report. All steps of the method 600 have been described in details in FIGS. 7 to 11 below.

FIG. 7A illustrates the serving cell (111) selecting potential coordinated cell for uplink (UL) monitoring (step 602 of the method 600) in details, according to an embodiment of the present invention. In the step of 702, the serving cell (111) inspects historical handover record of attached user equipment (UE) with an associated coordinated cell. In an embodiment, the UE is identified based on International Mobile Subscriber Identity (IMSI). Further, in an embodiment, the inspection is carried out when traffic demands are low. In another embodiment, the inspection can be carried at any time. In the step of 704, it is determined if the historical handover record for the attached UE is available. If the historical handover record for the attached UE is not available, then the serving cell (111) proceeds with the next coordinated cell's inspection at step 706. If the historical handover record for this UE with the associated coordinated cell is available, the serving cell (111) then add this UE's historical handover record to a list containing all the associated coordinated cells with this UE in descending order as illustrated at step of 706. FIG. 7B illustrates the example of the attached UE's historical handover record. At step 706 and step 7014, the serving cell (111) sends the UL activate monitoring command message to N coordinated cells whereby N=MAX; if N>MAX, and N=N; if N<MAX. In an embodiment, the UL activate monitoring command messages is a class 2 message utilizes S1AP or X2AP protocol with the introduction of new elementary procedure known as UL monitoring (711) in FIG. 7B and messages of UE identification (712) in FIG. 7B, reporting interval (713) in FIG. 7B as defined in 3GPP TS 36.331 and scheduling information 1014 in FIG. 7B. In an embodiment, the message of class 2 is unidirectional messages that are not explicitly acknowledged by the receiving entity.

Example of Table containing the Historical Attached UE's Handover Records associated with the Specific Coordinated Cells is shown below:

| Physical Cell ID | Number of Handover |
|---|---|
| 10 | 13 |
| 15 | 4 |
| 13 | 2 |
| 18 | 1 |

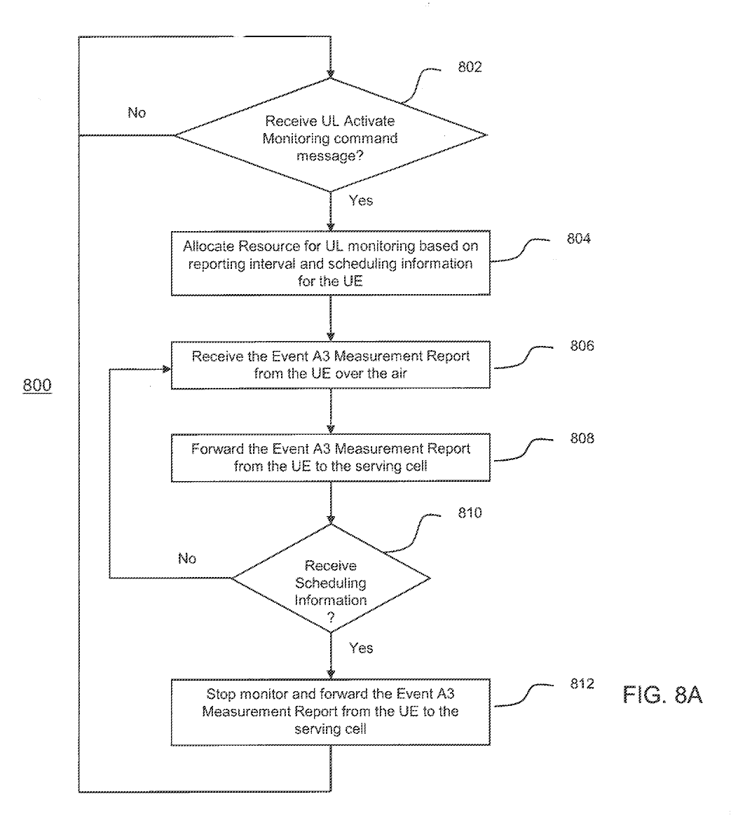

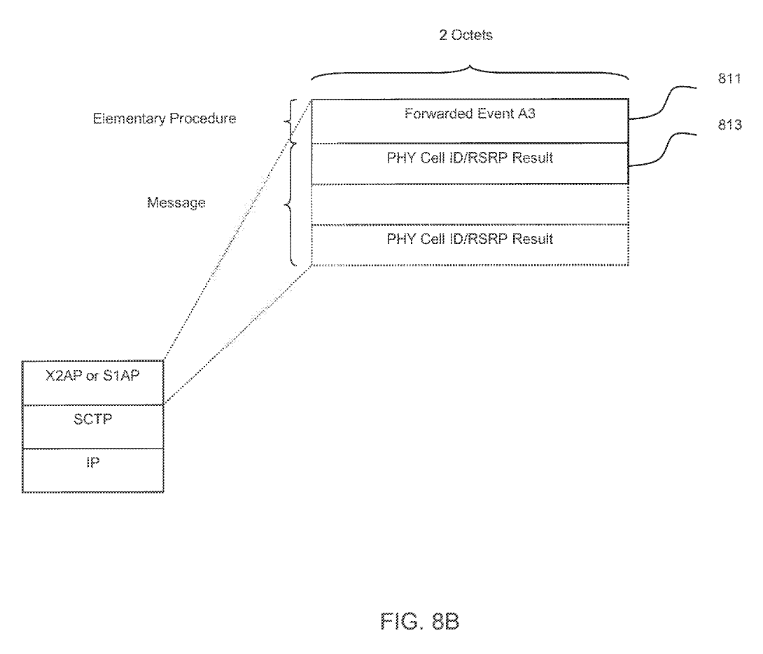

FIG. 8A illustrates the coordinated cell handling the UL activate monitoring command message from the serving cell as well as the method of forwarding the event A3 measurement report from the UE to the serving cell (step 604 and step 606 of the method 600) in details. In the step of 802, the coordinated cell (112) waits for the UL activate monitoring command message from the serving cell. In the step of 804, once the coordinated cell (112) receives the UL activate monitoring command message, it starts to allocate resource for receiving the event A3 measurement report based on the scheduling information and reporting interval. In the step of 806, the coordinated cell (112) receives the event A3 measurement report from the UE and in the step of 808, the coordinated cell forwards the event A3 measurement report from the UE to the serving cell. FIG. 8B illustrates the forwarded event A3 measurement report message format with the introduction of new elementary procedure known as Forwarded Event A3 (811). The number of PHY cell ID and its corresponding RSRP message (813) in FIG. 8B are based on the UE measurement. In the step of 810, if the coordinated cell (112) has not received the scheduling information, the coordinated cell keeps continue forwarding the event A3 measurement report to the serving cell. If the coordinated cell (112) has successfully received the scheduling information, the coordinated cell stops monitoring of the event A3 measurement report from the UE as shown at step 812.

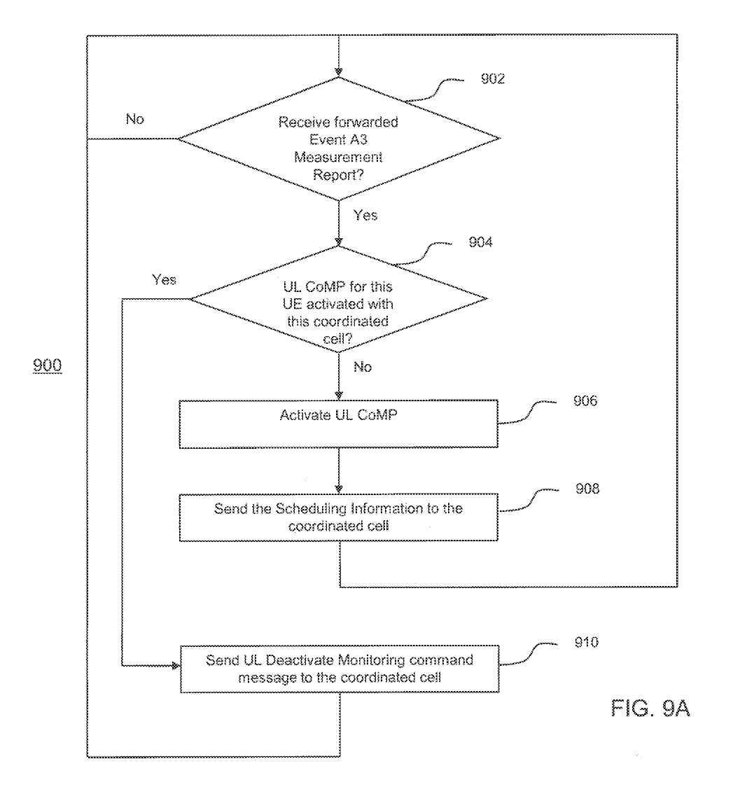

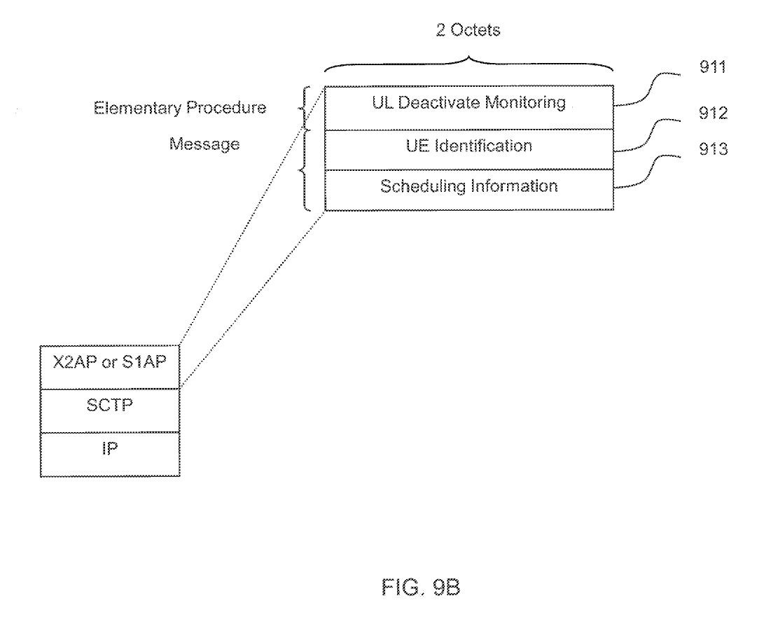

FIG. 9A illustrates the serving cell handling the forwarded event A3 measurement report from the coordinated cell (step 610 of the method 600) in details, according to an embodiment of the present invention. In the step of 902, the serving cell (111) monitors the incoming S1AP or X2AP message from the coordinated cell and determines whether its elementary procedure is forwarded event A3. If it is true, the service cell (111) proceed to inspect whether UL CoMP for this UE has been activated with this coordinated cell at step 904. If no, the servicing cell (111) activates the UL CoMP and sends the scheduling information to the coordinated cell at step 906 and at step 908 respectively. In an embodiment, the scheduling information is sent only if the UE meets the selection criteria to enjoy the benefit of UL CoMP. If UL CoMP has been activated during the inspection at step 904, the serving cell(111) then proceeds to send the UL deactivate monitoring command message to the coordinated cell to free the resources allocated for UL CoMP monitoring at step 910. FIG. 9B illustrates the UL deactivate monitoring command message format with the introduction of new elementary procedure known as UL Deactivate Monitoring 911 in FIG. 9B, followed by 2 octets of UE identification message 913 in FIG. 9B and 2 octets of scheduling information message 915 in FIG. 9B.

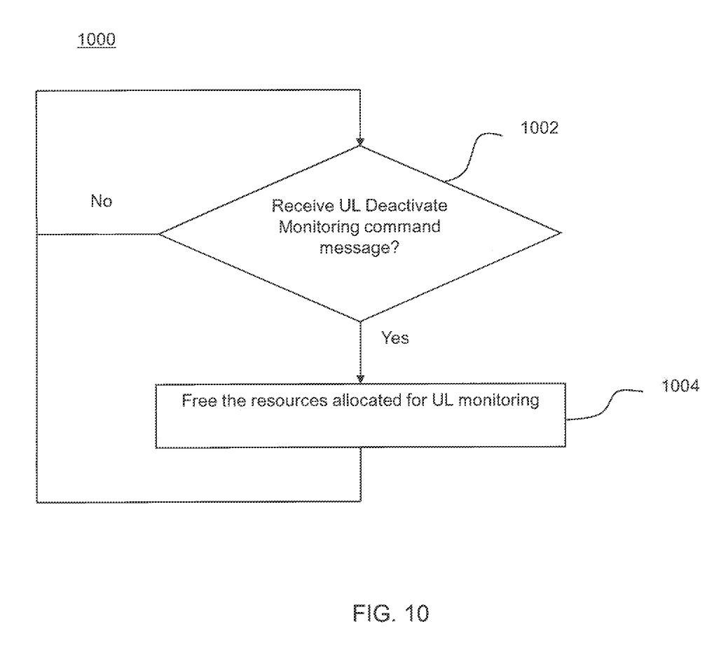

FIG. 10 illustrates a method of the coordinated cell handling the UL deactivate monitoring command message, according to an embodiment of the present invention. In the step of 1002, the coordinated cell (112) waits for incoming S1AP or X2AP messages and determines whether its elementary procedure is UL Deactivate Monitoring. If it is true, at step 1004, the coordinated cell (112) proceeds to free the allocated resource for UL monitoring based on the scheduling information and UE identification. Otherwise, the method returns to step 1002.

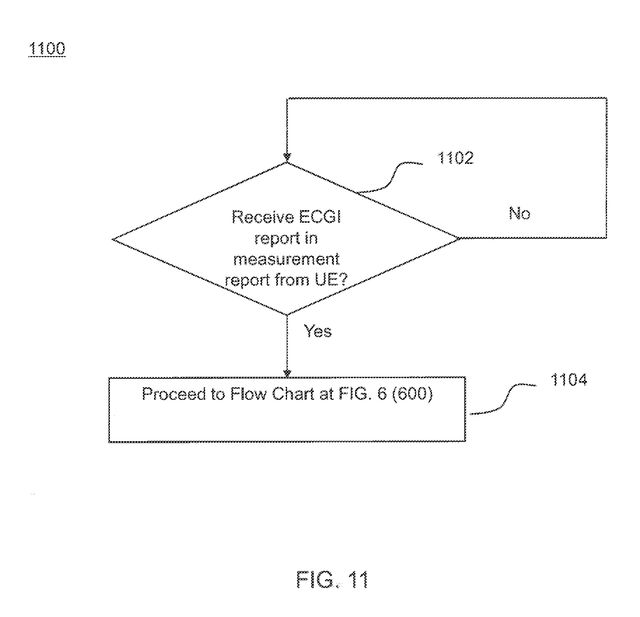

FIG. 11 illustrates method of adding new cells using ANR function, according to an embodiment of the present invention. At step 1102, it is determined if the ECGI report from the particular UE (113) is received. If the ECGI report from the particular UE (113) is available, procedures as illustrated in 600 in FIG. 6 proceed, otherwise the method returns to step 1102.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for enhancing robustness of uplink coordinated multi-point (UL CoMP) procedure in a long term evolution (LTE) communication network (100), the method comprising:
selecting at least one coordinated cell (112), by a serving cell (111), for uplink (UL) monitoring of a user equipment (113);
sending a UL activate monitoring command message, by the serving cell (111), to the at least one coordinated cell (112);
receiving an event A3 measurement report by the serving cell (111), from the at least one coordinated cell (112); and
performing UL CoMP procedure, by the serving cell (111), upon receiving the event A3 measurement report.

2. The method of claim 1, wherein the selecting comprises inspecting user equipment's historical handover record with the at least one coordinated cell (112).

3. The method of claim 2, wherein number of coordinated cells (112) selected for UL monitoring for event A3 measurement report for the user equipment (113) is based on a pre-determined maximum number of allowed coordinated cells.

4. The method of claim 3, wherein the maximum number of allowed coordinated cells (112) is determined based on resources available in the serving cell (111) for S1AP or X2AP messages exchanging.

5. The method of claim 1, wherein the sending comprises sending the at least one UL activate monitoring command message first to the coordinated cell (112) containing a highest number of handover records for the user equipment (113) and followed by other coordinated cells listed in descending order.

6. The method of claim 1, wherein the UL activate monitoring command message comprises UL activate monitoring, user equipment identification, periodic reporting interval, and scheduling information.

7. The method of claim 1 further comprising disabling uplink (UL) monitoring of event A3 measurement report from the user equipment (113).

8. The method of claim 7 further comprising inspecting whether a UL coordinated multi-point (CoMP) procedure for the user equipment (113) is activated with a corresponding coordinated cell (112).

9. The method of claim 8 further comprising sending a UL deactivate monitoring command message to the coordinated cell (112) if UL CoMP has been activated.

10. The method of claim 9, wherein the UL deactivate monitoring command message comprises UL deactivate command, user equipment identification, and scheduling information.

11. The method of claim 1 further comprising including a newly added cell for UL CoMP and UL monitoring after completion of automatic neighbor registration (ANR) procedures.

12. The method of claim 11, wherein the ANR is completed after ECGI report is received via a measurement report by the user equipment(113).

13. A method for a coordinated cell (112) to perform uplink (UL) monitoring of event A3 measurement report from a user equipment(113) in a long term evolution (LTE) communication network (100), the method comprising:
receiving, by the coordinated cell (112), a UL activate monitoring command message from a serving cell (111);
allocating resources for the UL monitoring of the user equipment (113);
forwarding an event A3 measurement report to the serving cell (111); and
deactivating the UL monitoring after receiving of scheduling information from the serving cell (111).

14. The method of claim 13, wherein the allocating comprises allocating resources based on decoding messages of the UL activate monitoring command message.

15. The method of claim 13, wherein the event A3 measurement report comprises event A3, physical cell identification, and reference signal received power (RSRP) result information.

16. The method of claim 13 further comprising freeing resources for UL monitoring after receiving the scheduling information.
